(19) United States
(12) Patent Application Publication
(10) Pub. No.: US 2019/0152345 A1
(43) Pub. Date: May 23, 2019

(54) Child Safety System

(71) Applicant: Joann Oranges, Tuckahoe, NY (US)

(72) Inventor: Joann Oranges, Tuckahoe, NY (US)

(21) Appl. No.: 15/820,416

(22) Filed: Nov. 21, 2017

(51) Int. Cl. B60N 2/00; B60Q 9/00; G08B 21/02

(52) U.S. Cl. CPC B60N 2/002; B60Q 9/00; B60N 2/28; B60Y 2400/305; G08B 21/0205

(57) ABSTRACT

A child safety system for inhibiting a child from being left unattended in a vehicle includes a vehicle that has an electrical system and an alarm system. The alarm system selectively emits an audible alarm. A car seat is provided and the car seat is selectively positioned in the vehicle to have a child seated therein. A weight sensor is positioned in the car seat to detect a weight of the child. The weight sensor is electrically coupled to the electrical system in the vehicle. Moreover, the alarm system selectively emits an audible alarm when the child is left unattended in the vehicle. In this way, a caregiver may be notified that the child is left unattended.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to safety devices and more particularly pertains to a new safety device for inhibiting a child from being left unattended in a vehicle.

### BRIEF SUMMARY OF THE INVENTION

An embodiment of the disclosure meets the needs presented above by generally comprising a vehicle that has an electrical system and an alarm system. The alarm system selectively emits an audible alarm. A car seat is provided and the car seat is selectively positioned in the vehicle to have a child seated therein. A weight sensor is positioned in the car seat to detect a weight of the child. The weight sensor is electrically coupled to the electrical system in the vehicle. Moreover, the alarm system selectively emits an audible alarm when the child is left unattended in the vehicle. In this way, a caregiver may be notified that the child is left unattended.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a car seat of a child safety system according to an embodiment of the disclosure.

FIG. 2 is a right side phantom view of a car seat of an embodiment of the disclosure.

FIG. 3 is a front phantom view of a car seat of an embodiment of the disclosure.

FIG. 4 is a back view of a car seat of an embodiment of the disclosure.

FIG. 5 is a perspective in-use view of an embodiment of the disclosure.

FIG. 6 is a schematic view of an embodiment of the disclosure.

### DETAILED DESCRIPTION OF THE INVENTION

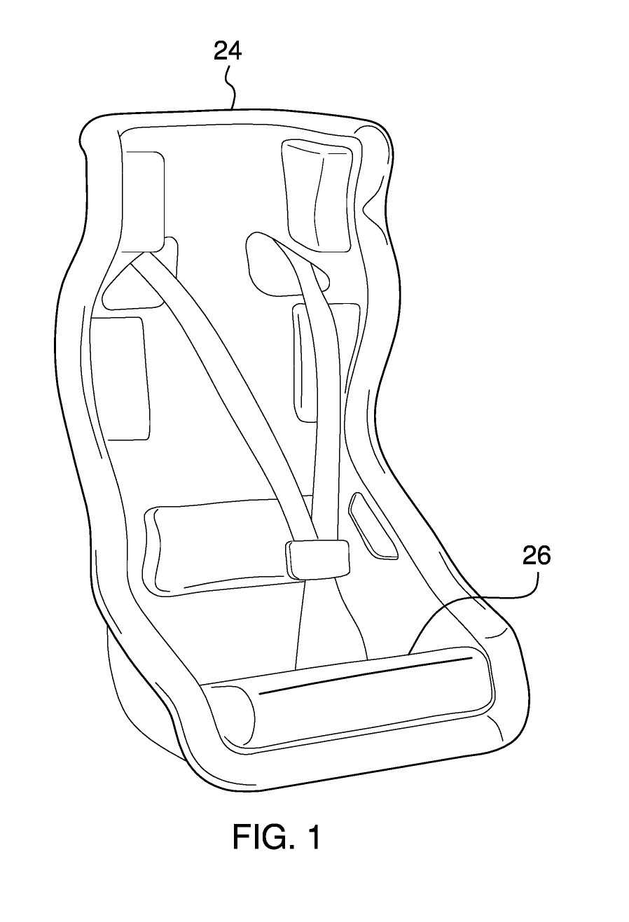

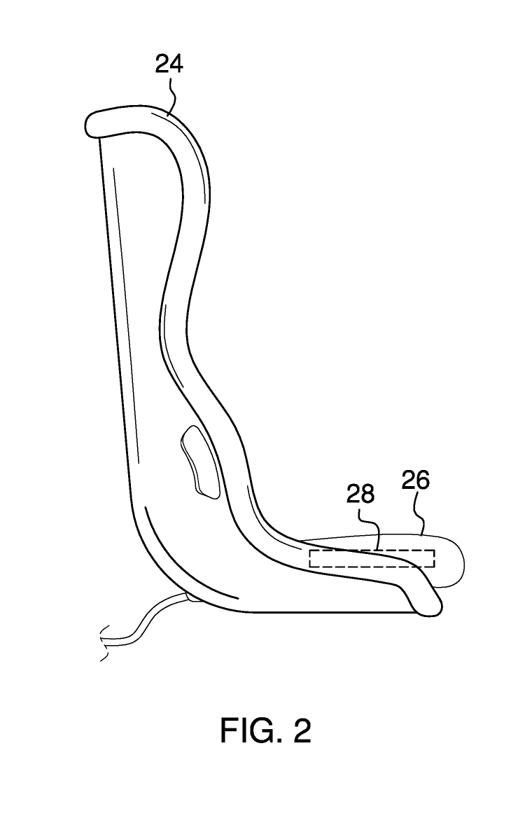

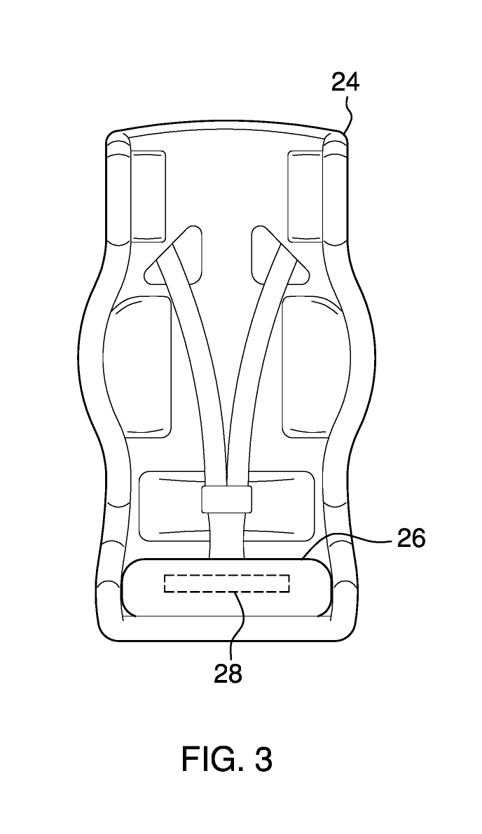

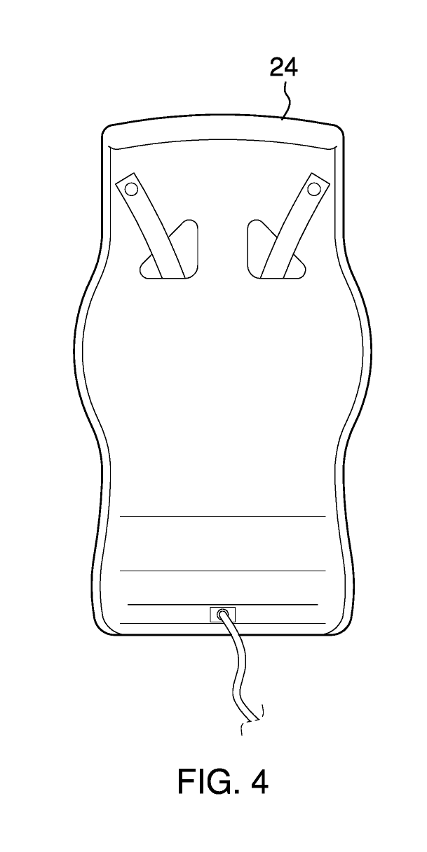

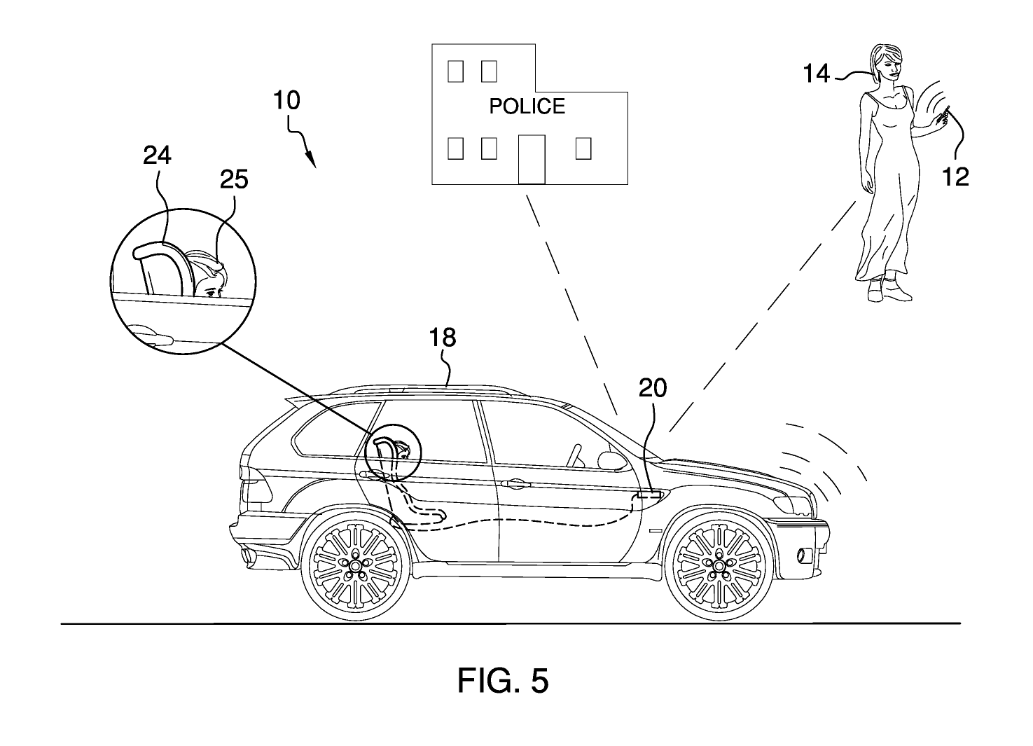

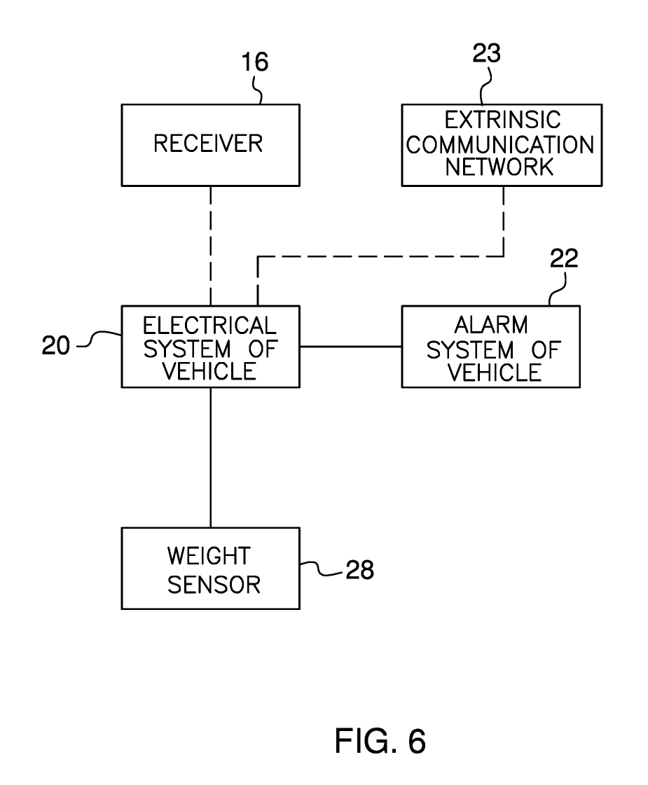

With reference now to the drawings, and in particular to FIGS. 1 through 6 thereof, a new safety device embodying the principles and concepts of an embodiment of the disclosure and generally designated by the reference numeral 10 will be described.

As best illustrated in FIGS. 1 through 6, the child safety system 10 generally comprises an electronic device 12 that may carried by a caregiver 14. The caregiver 14 may be a parent, a legal guardian of a child and any other adult caregiver. The electronic device 12 has a receiver 16 and the electronic device 12 may be a smart phone or the like. The receiver 16 may be a radio frequency receiver or the like.

A vehicle 18 is provided that has an electrical system 20 and an alarm system 22. The alarm system 22 selectively emits an audible alarm and the alarm system 22 may be a car theft alarm system of any conventional design. Additionally, the electrical system 20 may include a transceiver or the like. In this way the electrical system 20 may be wireless electrical communication with an extrinsic communication network 23. The electrical system 20 may be in wireless electrical communication with the receiver 16 in the electronic device 12. The extrinsic communication network 23 may be the Internet, a cellular phone communication network and any other wireless electronic communication network.

The vehicle 18 may be a passenger vehicle and any other vehicle used to transport people. The electrical system 20 selectively generates an alarm sequence and the alarm system 22 is turned on when the electrical system 20 generates the alarm sequence. The electrical system 20 may include an electronic processor. A car seat 24 is provided and the car seat 24 is selectively positioned in the vehicle 18 to have a child 25 seated therein. The car seat 24 has a chair portion 26 and the car seat 24 may be a child 25 safety car seat 24 of any conventional design.

A weight sensor 28 is provided and the weight sensor 28 is positioned in the car seat 24. The weight sensor senses a weight of the child 25 when the child 25 sits in the car seat 24. The weight sensor 28 is electrically coupled to the electrical system 20 in the vehicle 18. Additionally, the weight sensor may be an electronic weight sensor or the like having a trigger weight of approximately 4.5 kg.

A conductor may be provided and the conductor may be electrically coupled between the weight sensor 28 and the electrical system 20. Alternatively, the weight sensor 28 may include a transmitter and the transmitter may be in wireless electrical communication with the transceiver in the electrical system 20. The electrical system 20 generates the alarm sequence when the weight sensor 28 detects the weight of the child 25 and the vehicle 18 is parked. In this way the alarm system 22 and the electronic device 12 notifies the caregiver 14 that the child 25 has been left unattended in the vehicle 18.

The electrical system 20 in the vehicle 18 may include an electronic timer. The electronic timer may begin a countdown sequence when the electrical system 20 generates the alarm sequence. The transceiver in the electrical system 20 may contact emergency responders through the extrinsic communication network 23 when the countdown sequence elapses. The countdown sequence may be a duration of time ranging between 10 minutes and 15 minutes. In this way the emergency responders may be notified of a potential emergency with respect to the child 25 being left unattended in the vehicle 18. The emergency responders may be law enforcement, firefighters, and any other emergency responders that may be contacted via 911.

In use, the car seat 24 is placed in the vehicle 18 and the weight sensor 28 is electrically coupled to the electrical system 20 in the vehicle 18. The electronic device is synced with the transceiver in the electrical system via Bluetooth communication protocols and any other means of wireless electrical communication. The child 25 is placed in the car seat 24 and the vehicle 18 is driven. The electrical system 20 in the vehicle 18 generates the alarm sequence when the vehicle 18 is parked and the weight sensor 28 senses that the child 25 is seated in the car seat 24. Thus, the alarm system 22 emits the audible alarm and the electronic device 12 generates the alarm. In this way the caregiver 14 is notified that the child 25 has been left unattended in the vehicle 18 and may be potentially harmed due to exposure to extreme temperature.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A child safety system being configured to emit an audible alarm when a child is left in the vehicle, said system comprising:
a vehicle having an electrical system and an alarm system, said alarm system being configured to selectively emit an audible alarm;
a car seat being selectively positioned in said vehicle wherein said car seat is configured have a child seated therein; and
a weight sensor being positioned in said car seat wherein said weight sensor is configured to detect a weight of the child, said weight sensor being electrically coupled to said electrical system in said vehicle, said alarm system selectively emitting an audible alarm when the child is left unattended in said vehicle as indicated by said weight sensor detecting a weight in said car seat being greater than a trigger weight of 4.5 kilograms.

2. The system according to claim 1, further comprising an electronic device being configured to be carried by a first user, said electronic device having a receiver, said electronic device selectively generating an alarm.

3. The system according to claim 2, wherein said electrical system is in wireless electrical communication with said receiver, said electrical system being configured to be in electrical communication with an extrinsic communication network.

4. The system according to claim 3, wherein said electrical system selectively generates an alarm sequence, said alarm system being turned on when said electrical system generates said alarm sequence.

5. The system according to claim 4, wherein said electronic device generates said alarm when said electrical system generates said alarm sequence.

6. The system according to claim 4, wherein said electrical system generates said alarm sequence when said weight sensor detects the weight of the child and said vehicle is parked wherein said alarm system is configured to notify a caregiver that the child has been left unattended in said vehicle.

7. A child safety system being configured to emit an audible alarm when a child is left in the vehicle, said system comprising:
an electronic device being configured to be carried by a caregiver, said electronic device having a receiver;
a vehicle having an electrical system and an alarm system, said alarm system being configured to selectively emit an audible alarm, said electrical system being configured to be in electrical communication with an extrinsic communication network, said electrical system being in wireless electrical communication with said receiver, said electrical system selectively generating an alarm sequence, said alarm system being turned on when said electrical system generates said alarm sequence;
a car seat being selectively positioned in said vehicle wherein said car seat is configured have a child seated therein, said car seat having a chair portion; and
a weight sensor being positioned in said car seat, wherein said weight sensor is configured to detect a weight of a child, said weight sensor being electrically coupled to said electrical system in said vehicle, said electrical system generating said alarm sequence when said weight sensor detects a weight in said car seat being greater than a trigger weight of 4.5 kilograms and said vehicle is parked wherein said alarm system is configured to notify the caregiver that the child has been left unattended in said vehicle.
